(19) United States
(12) Patent Application Publication
(10) Pub. No.: US 2014/0012632 A1
(43) Pub. Date: Jan. 9, 2014

(54) EXTENSION OF BUSINESS SCENARIOS

(71) Applicants: Johann KEMMER, Muehlhausen (DE); Thomas WALTER, Muehlhausen (DE); Joachim FIESS, Karlsruhe (DE); Roland BRECHTER, St. Leon-Rot (DE); Joerg WELLER, Wieblingen (DE); Rico ZIENKE, Legde (DE); Juergen KLENK, Schaebisch Hall (DE)

(72) Inventors: Johann KEMMER, Muehlhausen (DE); Thomas WALTER, Muehlhausen (DE); Joachim FIESS, Karlsruhe (DE); Roland BRECHTER, St. Leon-Rot (DE); Joerg WELLER, Wieblingen (DE); Rico ZIENKE, Legde (DE); Juergen KLENK, Schaebisch Hall (DE)

(73) Assignee: SAP AG, Walldorf (DE)

(21) Appl. No.: 13/542,352

(22) Filed: Jul. 5, 2012

(51) Int. Cl. G06Q 10/06

(52) U.S. Cl. 705/7.36

(57) ABSTRACT

A search area to search business scenarios may be displayed on a display device. Business data flow(s) may be displayed on the display device based on a search criteria specified in the search area. Each business scenario defined for extension purposes may include a plurality of business objects. In response to identification of a business scenario from the business scenario(s), an integrated development environment may be displayed on the display device. The integrated development environment may include functionality to add extension field(s) to business object(s) included in the business scenario. In response to input indicating extension field(s), the extension field(s) may be added to the business object(s) included in the business scenario.

### BACKGROUND

Business software such as enterprise resource planning (ERP) software implements business processes by modeling business data as business objects (BOs) with data exchange between the BOs. The business data provided via BOs can be accessed through mechanisms such as user interfaces, forms, and analytical reports.

Traditionally, to provide a third party (such as a partner or the software consumer) the ability to extend BOs, software providers furnished the third party with software development tools that enable the third party to build add-ons to the standard business software. The software development tools may provide the ability to add new attributes to individual standard BOs. However, the third party may want to extend all BOs in a business scenario, and in order to do so, the third party may have to individually modify every BO with its data exchange in that business scenario. Such an approach can be problematic, because the data exchange between BOs might not be exposed to third party development and the development would be highly time-consuming and error-prone with respect to consistency of all related singular BO enhancements.

### BRIEF DESCRIPTION OF THE DRAWINGS

FIG. 1 illustrates a business scenario according to an embodiment.

FIG. 2 illustrates a graphical user interface (GUI) to search for extendable data flows according to an embodiment.

FIG. 3 illustrates a GUI to identify BO(s) to extend from an extendable business scenario according to an embodiment.

FIG. 4 illustrates an integrated development environment (IDE) to extend business scenario(s).

FIG. 5 shows an exemplary architecture in an embodiment.

### DETAILED DESCRIPTION

Embodiments may be discussed in systems to efficiently extend business scenarios.

In an embodiment, a search area to search business scenarios may be displayed on a display device. Business scenario(s) may be displayed on the display device based on a search criteria specified in the search area. Each business scenario may include a plurality of business objects. In response to identification of a business scenario from the business scenario(s), an integrated development environment may be displayed on the display device. The integrated development environment may include functionality to add extension field(s) to business object(s) included in the business scenario. In response to input indicating extension field(s), the extension field(s) may be added to the business object(s) included in the business scenario.

In an embodiment, the added extension field(s) may be propagated to all business objects included in the business scenario. In an embodiment, the integrated development environment may present automatically generated programming code indicating the business scenario and the business object(s) included in the business scenario. In an embodiment, the search criteria may indicate business object(s), wherein the displayed business scenario(s) may include the business object(s) indicated in the search criteria. In an embodiment, the search criteria may indicate business scenario(s). The displayed business scenario(s) may be the business scenario(s) indicated in the search criteria. In an embodiment, in response to the identification of the business scenario from the business scenario(s), a display device may display business scenarios including any business objects included in the identified business scenario.

Business software usually includes a standard set of BOs which can be utilized by the software user. For example, in an embodiment, business software may include BOs representing sales orders, sales quotes, customer quotes, service documents, and business opportunities. Each BO may include attributes and/or other BOs predefined by the software provider, and may be referred to as nodes. For example, a business opportunity BO may include one or more business process variant types, business transaction documents, overviews, parties, sales and service business areas, sales cycles, sales cycle assistants, and sales forecasts. Here, business process variant types, business transaction documents, overviews, parties, sales and service business areas, sales cycles, sales cycle assistants, and sales forecasts may be referred to as nodes of the business opportunity BO.

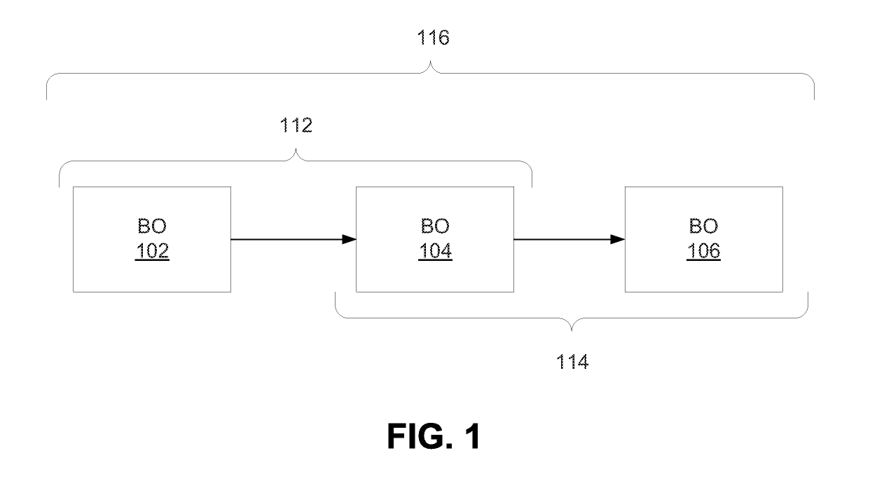

FIG. 1 illustrates a business scenario according to an embodiment. Business software consumers may create predefined BOs (and/or instances of predefined BOs), assign values to the created BOs, and link the BOs to model one or more business scenarios. For example, in an embodiment, BO 102 may be a business opportunity. This BO may include details such as the parties involved in the business opportunity such as the vendor, a prospective client, and a product being pitched to the prospective client. The business opportunity may result in the prospective client asking for a sales quote, which may be represented in the business software by BO 104. The information in the business opportunity BO 102 may be communicated to the sales quote BO 104. In an embodiment, the communication between BOs may occur through one or more function calls. In an embodiment, the communication between BOs may occur via one or more messages sent from one BO to another BO. In an embodiment, the information about the vendor, the prospective client, and the product may be copied from the business opportunity BO 102 to the sales quote BO 104. The communication of data between one BO to another may be called a data flow. For example, the communication of data between BO 102 and BO 104 may be data flow 112.

In an embodiment, after a sales quote is received by a prospective client, the prospective client may place a sales order based on the quote. The sales order may be represented by BO 106. There may be a data flow 114 between the sales quote BO 104 and the sales order BO 106. In an embodiment, the information about the vendor, the client, and the product may be copied from the sales quote BO 104 to the sales order BO 106. The communication chain of data between one or more BOs may be called a business scenario. In an embodiment, a business scenario may not have a communication gap between BOs in the business scenario. In other words, a business scenario may be one or more data flows without any communication gaps between the BOs of the data flows. Thus, data flow 112 may be a business scenario, data flow 114 may be a business scenario, and the combination 116 of data flows 112 and 114 may be a business scenario.

In an embodiment, the software provider may provide the software to a third party, called a software partner, and the software partner may customize the software further and provide the software to the ultimate software consumer. The software partner may customize the software to fit particular needs of a type of consumer.

For example, in an embodiment, a business software consumer such as an automobile seller may be interested in purchasing business software to model the consumer's business. A software provider may provide business software with generic BOs to a partner specializing in the automobile industry. The business software with generic BOs may include a generic sales quote BO 104. The generic sales quote BO 104 may include a field to specify a type of product such as a car. However, the generic sales quote BO 104 may not allow for enough granularity to specify the exact make and model of the car. Therefore the software provider may provide the partner with tools to extend the generic sales quote BO 104. Since the partner specializes in the automobile industry, the partner may extend the generic sales quote BO such that the exact make and model of the car can be specified. The partner may then provide the software to the business software consumer (the automobile seller) with the added functionality. In an embodiment, the software provider may directly provide the business software consumer with tools to extend the generic sales quote BO 104. Thus, instead of the partner, the business software consumer may extend the generic sales quote BO such that the exact make and model of the car can be specified.

Traditionally, to provide a third party (such as a partner or the software consumer) the ability to extend BOs, software providers furnished the third party with software development tools that enable the third party to build add-ons to the standard business software. The software development tools may provide the ability to add new attributes to individual standard BOs. However, the third party may want to extend all BOs in a business scenario, and in order to do so, the third party may have to individually modify every BO with its data exchange in that business scenario. Such an approach can be problematic, because the data exchange between BOs might not be exposed to third party development and the development would be highly time-consuming and error-prone with respect to consistency of all related singular BO enhancements.

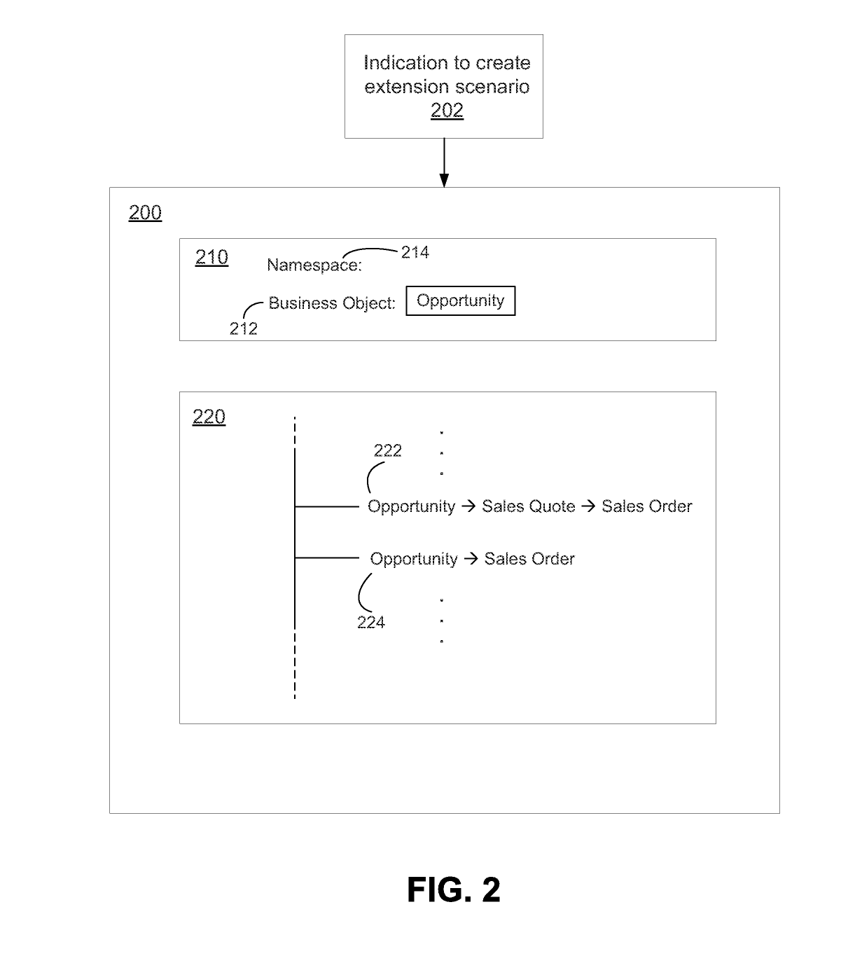

In an embodiment, a graphical user interface (GUI) may be utilized by a user (such as a partner or a software consumer) to extend business scenarios. FIG. 2 illustrates a GUI to search for extendable business data flows (and/or business scenarios) according to an embodiment. In response to an indication to create a new business scenario extension 202, a GUI such as the GUI 200 may be displayed. The GUI 200 may be a GUI to search for existing business data flows which can be extended. The GUI 200 may include a first area 210 to specify search parameters for existing business data flows. The GUI may include a second area 220 to display business data flow(s) matching the search parameters specified in the search area 210.

In an embodiment, the search area 210 may include parameter fields such as a namespace field 214 and/or a BO field 212. In an embodiment, specifying a particular BO, for example “opportunity,” in the BO field 212 and searching for available business data flows may display, in display area 220, the available business data flows which include the BO opportunity (222 and 224). One or more of the displayed business data flows may be selected and marked as a business scenario to be extended, for example via check boxes next to the business data flows, highlighting, etc.

In an embodiment, selecting one or more business data flows may display available business data flows related to the selected business data flow(s). In an example embodiment, since the business data flow 222 includes the three BOs, opportunity, sales quote, and sales order, selecting business data flow 222 may display all business data flows which include any one of the three BOs.

In an embodiment, the search area 210 may include parameter fields such as a business scenario field (not shown) and/or a data flow field (not shown) so that the available business data flows may be searched based on business scenario identifiers and/or data flow identifiers respectively. A person having ordinary skill in the art will appreciate that any search criteria capable of identifying business data flows may be displayed in search area 210.

In an embodiment, the available values for the search fields displayed in search area 210 may be shown via a pre-populated drop down menu. In an embodiment, the values for the search fields may be typed in manually as a text string.

In an embodiment, the search area 210 may include a field (not shown) to input a text string search query similar to a structured query language (SQL) query. For example, the search query, “select business_data_flow where business_object=‘opportunity’”, may display in display area 220 the available business data flows which include the BO opportunity (222 and 224). A person having ordinary skill in the art will appreciate that the exact syntax of the text search string may vary in other embodiments.

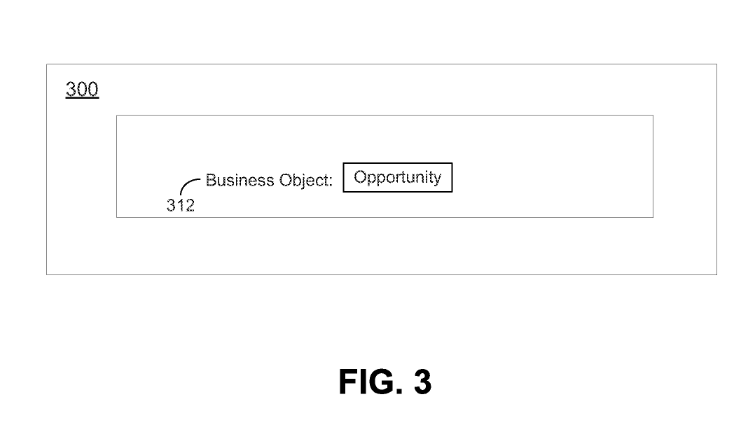

FIG. 3 illustrates a GUI to identify BO(s) to extend from a extendable business data flow (and/or business scenario) according to an embodiment. In an embodiment, after identifying the business data flow(s) which the user wants to extend (for example, by utilizing a GUI such as the one discussed in FIG. 2), the user may be presented with a GUI 300 to identify BO(s) to extend from the identified business data flows. The GUI 300 may include a BO field 312 to specify one or more BOs.

In an embodiment, the BO field 312 may list the BOs included in a business data flow/scenario previously identified for extension. For example, in an embodiment, the user may use GUI 200 (FIG. 2) to identify that he/she wishes to extend business data flow 222. As seen in FIG. 2, business data flow 222 includes three BOs: opportunity, sales quote, and sales order. Consequently, the field 312 may be pre-populated with the same three BOs: opportunity, sales quote, and sales order. The user may then identify one or more of the three BOs to extend. In an embodiment the field 312 may include a drop down menu, a drop down list, a static list, radio buttons, check boxes, or any such mechanism which is capable of displaying BOs and allows for selection of one or more BOs.

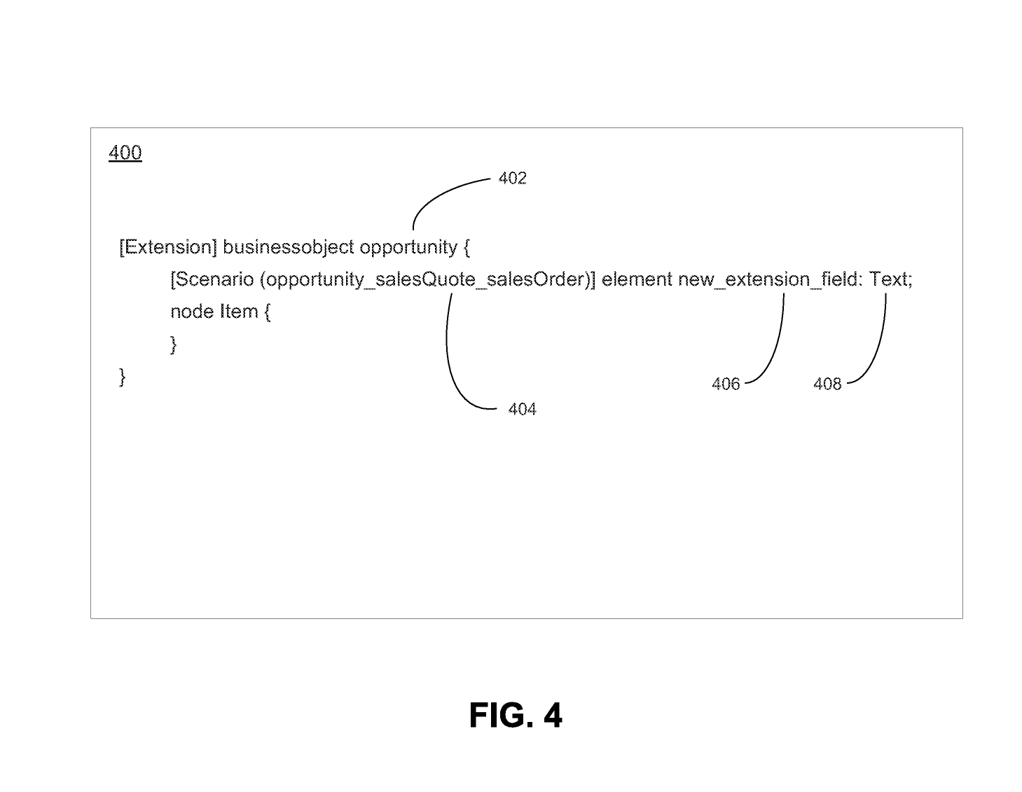

FIG. 4 illustrates an integrated development environment (IDE) to extend business scenario(s) (and/or data flow(s)). In an embodiment, after identifying the business scenario(s) which the user wants to extend (for example, by utilizing a GUI such as the one discussed in FIG. 2), and identifying corresponding BO(s) from the business scenario(s) (for example, by utilizing a GUI such as the one discussed in FIG. 3), the user may be presented with an IDE 400 to create one or more new extension fields for the identified BO(s) associated with the business scenario(s).

In an embodiment, the IDE may be pre-populated with programming code necessary to add one or more new extension fields. For example, in an embodiment, the user may use GUI 200 (FIG. 2) to identify that he/she wishes to extend business scenario 222. As seen in FIG. 2, business scenario 222 includes three BOs: opportunity, sales quote, and sales order. In an embodiment, the user may use GUI 300 (FIG. 3) to identify that he/she wishes to extend the BO, opportunity. As a result, the IDE 400 may be automatically populated with programming code which includes instructions to extend the BO opportunity 402 (previously selected using GUI 300) belonging to the business scenario opportunity_salesQuote_salesOrder 404 (previously selected using GUI 200). The user may then specify the name of the new field being added and the data type of that new field. For example, in an embodiment, the user may add a new extension field called new_extension_field 406 of a text data type 408.

A person having ordinary skill in the art will appreciate that the programming language shown in IDE 400 is an example embodiment, and that other embodiments may incorporate any programming language including advanced business application programming (ABAP), C++, Java, C, C#, and Visual Basic. Similarly, a person having ordinary skill in the art will appreciate that an extension field can be of any data type, including, integer, floating point number, packed number, text, date, numeric text, time, hexadecimal, object (such as an object oriented object), and BO.

In an embodiment, once the user specifies the new extension field(s) and the corresponding data type(s) of the extension fields, the associated BO(s) will include the new extension field(s), and the user may have access to the newly defined extension field within the business software. For example, after defining the new field as described above using IDE 400, the BO opportunity, belonging to the business scenario, opportunity→sales quote→sales order, will include a new extension field of text data type, and the user may assign values to the new extension field.

In an embodiment, a new extension field added to one BO from a particular business scenario will automatically propagate the new extension field to all BOs associated with that particular business scenario. For example, after defining the new field as described above using IDE 400, all BOs (opportunity, sales quote, and sales order) belonging to the business scenario, opportunity→sales quote→sales order, will include the same new extension field of text data type.

A person having ordinary skill in the art will appreciate that the GUIs and IDE illustrated in FIGS. 2-4 may be displayed separately or may be displayed together as part of one or more other GUIs. In an embodiment, entering information in one GUI may trigger the display of another GUI. For example, identifying business scenarios using GUI 200 may trigger the display of GUI 300. The GUIs and IDE illustrated in FIGS. 2-4 may include buttons to confirm that a particular action was taken by the user. For example, GUI 200 may include button called “search” in the search area 210 so that the user can confirm that the user intends to search for business scenarios corresponding to the search parameters. A person having ordinary skill in the art will also appreciate that the GUIs and IDE illustrated in FIGS. 2-4 don't have to be displayed in any particular order.

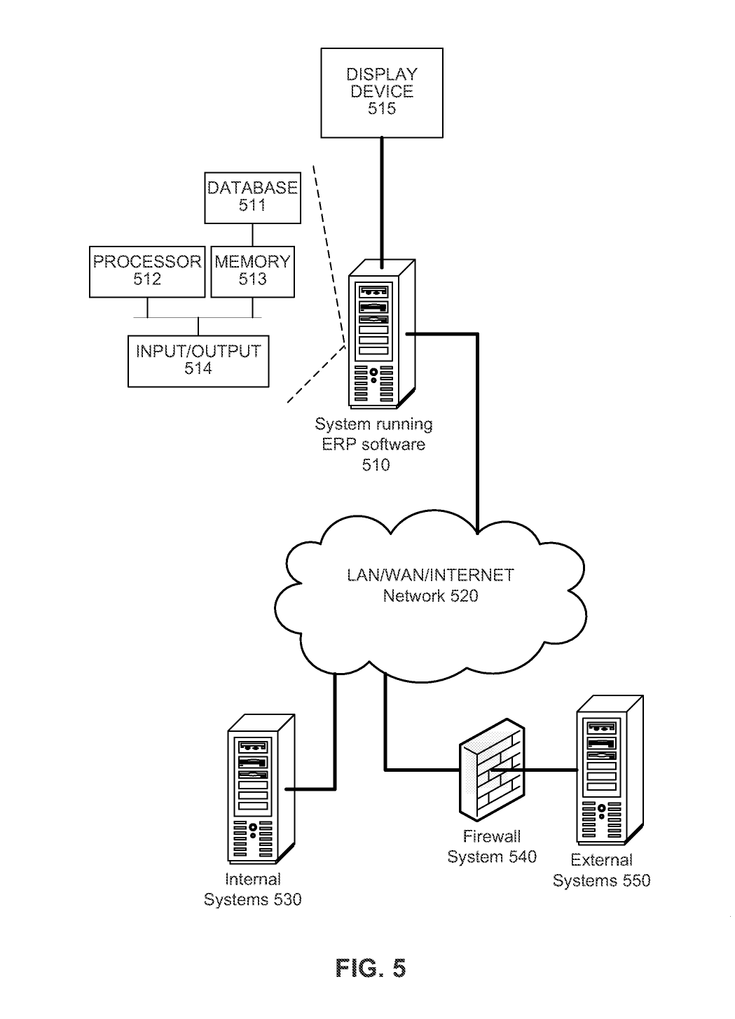

FIG. 5 shows an exemplary architecture in an embodiment of the invention. The system running an application to view, create, or modify BOs and/or business scenarios 510 may be coupled to a display device 515, existing internal systems 530 through a network 520 and to external systems 550 through the network 520 and firewall system 540. The system running an application to view, create, or modify BOs and/or business scenarios 510 may include a desktop computer, laptop computer, tablet PC, client computer, mobile phone, central computer in a vehicle, and any other computer. The display device 515 may include a computer monitor, a tablet PC screen, a mobile phone screen, and any other displays. The existing internal systems 530 may include a server and may provide business data and/or other data. The external systems 550 may include a server and may be maintained by a third party, such as an information service provider, and may contain business data and/or other data, that may be updated by the third party on a periodic basis. The system running an application to view, create, or modify BOs and/or business scenarios 510 may interact with these external systems to obtain updates through a firewall system 540 separating the internal systems from the external systems.

A person having ordinary skill in the art will appreciate that while internal systems 530 and external systems 550 are included in FIG. 5, in some embodiments, one or both of these systems may not be required. In an embodiment, the functionality provided by the internal systems 530 and external systems 550 may be provided by the system running the application to view, create, or modify BOs and/or business scenarios 510.

Each of the systems in FIG. 5 may contain a processing device 512, memory 513, a database 511, and an input/output interface 514, all of which may be interconnected via a system bus. In various embodiments, each of the systems 510, 530, 540, and 550 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 513 may contain different components for retrieving, presenting, changing, and saving data. Memory 513 may include a variety of memory devices, for example, Dynamic Random Access Memory (DRAM), Static RAM (SRAM), flash memory, cache memory, and other memory devices. Additionally, for example, memory 513 and processing device(s) 512 may be distributed across several different computers that collectively comprise a system.

Database 511 may include any type of data storage adapted to searching and retrieval. The database 511 may include SAP database (SAP DB), Informix, Oracle, DB2, Sybase, and other such database systems. The database 511 may include SAP's HANA (high performance analytic appliance) in-memory computing engine and other such in-memory databases.

Processing device 512 may perform computation and control functions of a system and comprises a suitable central processing unit (CPU). Processing device 512 may comprise a single integrated circuit, such as a microprocessing device, or may comprise any suitable number of integrated circuit devices and/or circuit boards working in cooperation to accomplish the functions of a processing device. Processing device 512 may execute computer programs, such as object-oriented computer programs, within memory 513.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, solid state drives, or DVD ROM; the Internet or other propagation medium; or other forms of RAM or ROM.

We claim:

1. A computer-implemented method to extend business scenarios comprising:
displaying a search area to search business scenarios;
displaying at least one business scenario based on search criteria specified in the search area, wherein each business scenario includes a plurality of business objects;
responsive to identification of a business scenario from the at least one business scenario, displaying an integrated development environment, wherein the integrated development environment includes functionality to add at least one extension field to at least one business object included in the business scenario; and
responsive to input indicating at least one extension field, adding the at least one extension field to the at least one business object included in the business scenario.

2. The method of claim 1, further comprising:
propagating the added at least one extension field to all business objects included in the business scenario.

3. The method of claim 1, wherein the integrated development environment presents automatically generated programming code indicating the business scenario and the at least one business object included in the business scenario.

4. The method of claim 1, wherein the search criteria indicates at least one business object, wherein the displayed at least one business scenario includes the at least one business object indicated in the search criteria.

5. The method of claim 1, wherein the search criteria indicates at least one business scenario, wherein the displayed at least one business scenario is the at least one business scenario indicated in the search criteria.

6. The method of claim 1, further comprising:
responsive to the identification of the business scenario from the at least one business scenario, displaying business scenarios including any business objects included in the identified business scenario.

7. An apparatus comprising:
a display to:
display a search area to search business data flows,
display at least one business scenario based on search criteria specified in the search area, wherein each business scenario includes a plurality of business objects, and
responsive to identification of a business scenario from the at least one business scenario, display an integrated development environment, wherein the integrated development environment includes functionality to add at least one extension field to at least one business object included in the business scenario; and
a processor for executing computer instructions, the processor configured to:
responsive to input indicating at least one extension field, add the at least one extension field to the at least one business object included in the business scenario.

8. The apparatus of claim 7, wherein the processor is further configured to propagate the added at least one extension field to all business objects included in the business scenario.

9. The apparatus of claim 7, wherein the integrated development environment presents automatically generated programming code indicating the business scenario and the at least one business object included in the business scenario.

10. The apparatus of claim 7, wherein the search criteria indicates at least one business object, wherein the displayed at least one business scenario includes the at least one business object indicated in the search criteria.

11. The apparatus of claim 7, wherein the search criteria indicates at least one business scenario, wherein the displayed at least one business scenario is the at least one business scenario indicated in the search criteria.

12. The apparatus of claim 7, wherein the display is further configured to:
responsive to the identification of the business scenario from the at least one business scenario, display business scenarios including any business objects included in the identified business scenario.

13. A non-transitory computer-readable medium embodied with computer-executable instructions for causing a computer to execute instructions, the computer instructions comprising:
displaying a search area to search business scenarios;
displaying at least one business scenario based on search criteria specified in the search area, wherein each business scenario includes a plurality of business objects;
responsive to identification of a business scenario from the at least one business scenario, displaying an integrated development environment, wherein the integrated development environment includes functionality to add at least one extension field to at least one business object included in the business scenario; and
responsive to input indicating at least one extension field, adding the at least one extension field to the at least one business object included in the business scenario.

14. The computer-readable medium of claim 13, wherein the computer instructions further comprise:
propagating the added at least one extension field to all business objects included in the business scenario.

15. The computer-readable medium of claim 13, wherein the integrated development environment presents automatically generated programming code indicating the business scenario and the at least one business object included in the business scenario.

16. The computer-readable medium of claim 13, wherein the search criteria indicates at least one business object, wherein the displayed at least one business scenario includes the at least one business object indicated in the search criteria.

17. The computer-readable medium of claim 13, wherein the search criteria indicates at least one business scenario, wherein the displayed at least one business scenario is the at least one business scenario indicated in the search criteria.

18. The computer-readable medium of claim 13, wherein the computer instructions further comprise:
responsive to the identification of the business scenario from the at least one business scenario, displaying business scenarios including any business objects included in the identified business scenario.
